(19) United States
(12) Patent Application Publication
(10) Pub. No.: US 2009/0146606 A1
(43) Pub. Date: Jun. 11, 2009

(54) Fuel Cell Apparatus with Charge Circuit

(75) Inventors: Ming-Yao Dong, ChuPei City (TW); Wen-Hsing Chang, ChuPei City (TW)

Correspondence Address: NIKOLAI & MERSEREAU, P.A., 900 SECOND AVENUE SOUTH, SUITE 820, MINNEAPOLIS, MN, 55402, US

(73) Assignee: SYSPOTEK CORPORATION, ChuPei City (TW)

(21) Appl. No.: 12/328,552

(22) Filed: Dec. 4, 2008

(30) Foreign Application Priority Data
Dec. 7, 2007 (TW) 096146689

(51) Int. Cl. H02J 7/00

(52) U.S. Cl. 320/101

(57) ABSTRACT

A fuel cell apparatus with charge circuit comprises a fuel cell, a power output circuit and a charge circuit. The power output circuit transmits the power outputted by the fuel cell and further comprises a sensor unit for detecting the power characteristics outputted by the power output circuit and outputs corresponding electrical signals. The charge circuit transmits power outputted by the fuel cell and comprises a secondary cell and a charging unit. The charging unit controls the charge circuit to perform the charging operation of the secondary cell, wherein the power output circuit is electrically connected in parallel with the charge circuit, while the fuel cell is electrically connected in series with the power output circuit. The charging unit performs the charging control of the charge circuit to the secondary cell according to electrical signals outputted by the sensor unit.

### FIELD OF THE INVENTION

The present invention relates to a fuel cell apparatus with charge circuit and more particularly, to a fuel cell apparatus which utilizes charging control of the charge circuit to achieve stable output control of the fuel cell apparatus.

### BACKGROUND OF THE INVENTION

Conventional fuel cell apparatus is a power generating apparatus which outputs power directly by utilizing the chemical reaction of hydrogen-containing fuel and oxygen, such as a direct methanol fuel cell (DMFC), a polymer electrolyte membrane (PEM) fuel cell and so on. For the power output of the fuel cell, operating conditions such as temperature and fuel supply concentration need to be controlled, in conjunction with power load. Thus, when the power supply needed by the load is not stable, it will cause difficulties in operation and control of the fuel cell. However for such fuel cell techniques, there is no apparatus or method relating to stable control of power supply of the power output terminal of the fuel cell.

Therefore, in light of drawbacks of conventional fuel cell apparatus, the inventor aims to develop a fuel cell apparatus with charge circuit.

### SUMMARY OF THE INVENTION

The main objective of the invention is to provide a fuel cell apparatus with charge circuit, the apparatus having a charge circuit for cooperating with the fuel cell apparatus to supply power needed by the load circuit and simultaneously adjust the power or current during charging of the secondary cell such that the fuel cell apparatus can output stable power.

Another objective of the invention is to provide a fuel cell apparatus with charge circuit, wherein the power output circuit has a sensor unit for detecting the power outputted by the fuel cell apparatus for being the basis of relating control.

Still another objective of the invention is to provide a fuel cell apparatus with charge circuit, wherein the power output circuit and the charge circuit has a voltage conversion unit respectively for controlling the voltage outputted by each circuit.

To achieve the above-mentioned objectives, the invention discloses a fuel cell apparatus with charge circuit, comprising a fuel cell, a power output circuit and a charge circuit. The power output circuit transmits the power outputted by the fuel cell and further comprises a sensor unit for detecting the characteristics of the power outputted by the power output circuit and outputs the electrical signals corresponding to the foresaid characteristics. The charge circuit transmits power outputted by the fuel cell and comprises a secondary cell and a charging unit. The charging unit controls the charge circuit to perform the charging operation of the secondary cell, wherein the power output circuit is electrically connected in parallel with the charge circuit, while the fuel cell is electrically connected in series with the power output circuit. The charging unit performs the charging control of the charge circuit to the secondary cell according to electrical signals outputted by the sensor unit.

According to the electrical signals outputted by the sensor unit, the above-mentioned charging unit determines power characteristics of the charge circuit to charge the secondary cell and stabilizes current level transmitted by the power output circuit in a reasonable range, or stabilizes current level outputted by the fuel cell in a reasonable range.

The above-mentioned sensor unit is disposed on the power output circuit and between the fuel cell and the electrical connection terminal connecting the power output circuit and the charge circuit.

Furthermore, in the above-mentioned power output circuit, the other terminal corresponding to the electrically connected fuel cell is a load terminal for power output. The sensor unit can be disposed on the power output circuit and between the electrical connection terminal connecting the power output circuit and the charge circuit and the load terminal. The fuel cell apparatus further comprises a first voltage conversion unit. The first voltage conversion unit is a circuit with DC power storage and release mechanism, and is electrically connected in series with the power output circuit. The first voltage conversion unit limits the output current value to be not greater than a rated current value. When the current value outputted by the first voltage conversion unit is smaller than the rated current value, the charging unit increases or decreases the current level of the charge circuit to perform the charging operation of the secondary cell, and the output current of the fuel cell is maintained in a stable state.

The above-mentioned fuel cell apparatus with charge circuit further comprises a control unit. The control unit is electrically connected with the sensor unit and the charging unit. Electrical signals outputted by the sensor unit are processed by the control unit. According to the outputted electrical signals of the sensor unit which are processed, and outputted by the control unit, the charging unit controls the charge circuit to supply power characteristics of the charging operation of the secondary cell.

The above-mentioned fuel cell apparatus with charge circuit can further comprise a second voltage conversion unit. The second voltage conversion unit is a circuit with DC power storage and release mechanism, and is electrically connected in series with the rear terminal of the secondary cell of the charge circuit. Besides, the second voltage conversion unit can limit the output current value to be not greater than a rated current value.

The objects, features and effects of the invention are described in detail below with embodiments in reference to the accompanying drawings.

### BRIEF DESCRIPTION OF THE DRAWINGS

FIG. 1 is a component diagram of the fuel cell apparatus with charge circuit according to the first embodiment of the invention;

FIG. 2 is a component diagram of the fuel cell apparatus with charge circuit according to the second embodiment of the invention;

FIG. 3 is a component diagram of the fuel cell apparatus with charge circuit according to the third embodiment of the invention;

FIG. 4 is a component diagram of the fuel cell apparatus with charge circuit according to the fourth embodiment of the invention; and

FIG. 5 is a component diagram of the fuel cell apparatus with charge circuit according to the fifth embodiment of the invention.

### DETAILED DESCRIPTION OF THE INVENTION

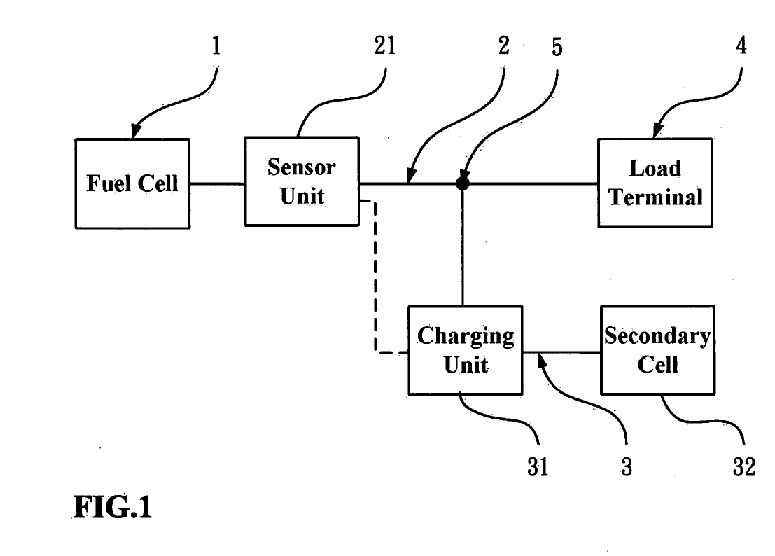

Referring to FIG. 1, which is the component diagram of the fuel cell apparatus with charge circuit according to the first embodiment of the invention. The invention relates to a fuel cell apparatus with charge circuit comprising a fuel cell (1), a power output circuit (2) and a charge circuit (3). A charging unit (31) determines the charging power according to the output power of the power output circuit (2).

In the above-mentioned fuel cell apparatus with charge circuit of the invention, the fuel cell (1) is a power generating apparatus utilizing the chemical reaction of hydrogen-containing fuel and oxygen to directly generate power output; the power output circuit (2) comprising a sensor unit (21) for detecting power characteristics such as voltage, current, power and so on outputted by the power output circuit (2); and the charge circuit (3) further comprising a secondary cell (32) and a charging unit (31), the secondary cell (32) being a chargeable power storage apparatus the charging unit (31) being a power control apparatus for controlling power or current supplying the charging of the secondary cell (32).

In the above-mentioned embodiment, the power output circuit (2) is electrically connected with the fuel cell (1) and transmits power generated by the fuel cell (1) to the load terminal (4). The sensor unit (21) can detect power characteristics of the power output circuit (2) and output electrical signals corresponding to the power characteristics. The charge circuit (3) is electrically connected in parallel with the power output circuit (2), and the sensor unit (21) of the power output circuit (2) is electrically connected with the charging unit (31) of the charge circuit (3). The charging unit (31) performs the charging control of the secondary cell (32) according to the electrical signals outputted by the sensor unit (21).

In the above-mentioned embodiment, more specifically, the sensor unit (21) of the power output circuit (2) detects the current level of the power output circuit (2), and the sensor unit (21) outputs electrical signals corresponding to the current level to the charging unit (31) of the charge circuit (3). The charging unit (31) controls the charge circuit (3) to perform the charging operation of the secondary cell (32) according to the corresponding current level, and stabilizes the current level transmitted by the power output circuit (2) in a reasonable range.

In the above-mentioned embodiment, the sensor unit (21) can be disposed on the power output circuit (2) and between the fuel cell (1) and the electrical connection terminal (5) connecting the power output circuit (2) and the charge circuit (3), for detecting the total output current, voltage or other electrical characteristics of the fuel cell (1).

In addition, the sensor unit (21) can be disposed on the power output circuit (2) and between the electrical connection terminal (5) connecting the power output circuit (2) and the charge circuit (3) and the load terminal (4), for detecting current amount outputted from the fuel cell (1) to the load terminal (4) or other electrical characteristics. Thus, in the above-mentioned embodiment, the sensor unit (21) in the power output circuit (2) can detect the current level supplied by the power output circuit (2) to the load terminal (4). According to the preset output current of the fuel cell (1) and electrical signals provided by the sensor unit (21), the charging unit (31) correspondingly controls current level of the charge circuit (3) to perform the charging operation of the secondary cell (32) and stabilizes the current level transmitted by the power output circuit (2) in a reasonable range.

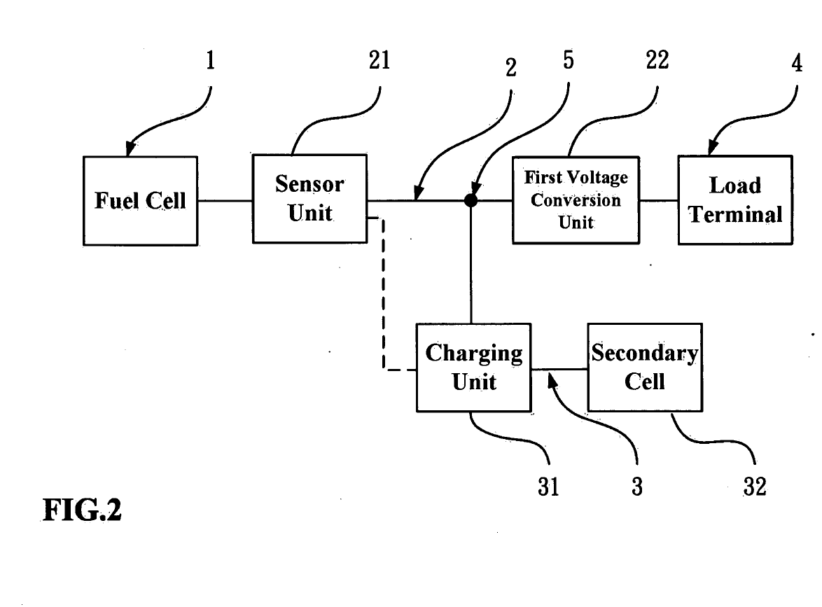

Referring to FIG. 2, which is the component diagram of the fuel cell apparatus with charge circuit according to the second embodiment of the invention. Based on the above-mentioned embodiment, the fuel cell apparatus with charge circuit according to the invention further comprises a first voltage conversion unit (22), the first voltage conversion unit (22) being a circuit with DC power storage and release mechanism and being electrically connected in series with the power output circuit (2), so that the power transmitted from the fuel cell (1) to the power output circuit (2) can be converted into a stable voltage outputted to the load terminal (4) for providing the power needed by the load terminal (4).

In the above-mentioned fuel cell apparatus with charge circuit of the invention, when the fuel cell (1) outputs power to the load terminal (4) through the power output circuit (2), the first voltage conversion unit (22) converts the voltage level from the power output circuit (2) to the load terminal (4), wherein according to the current level obtained by the power output circuit (2) and detected by the sensor unit (21), the charging unit (31) adjusts the current level when the secondary cell (32) is being charged, so that the total output current voltage or even the total output power of the fuel cell (1) is maintained in a stable state.

In the above-mentioned embodiment, the first voltage conversion unit (22) further comprises a DC-DC power boost circuit or a DC-DC power buck circuit, so that the first voltage conversion unit (22) can perform boost voltage conversion or buck voltage conversion, or even comprises a plurality of DC-DC power boost circuits or a plurality of DC-DC power buck circuits, so that the first voltage conversion unit (22) can respectively covert and output power of a plurality of various voltages.

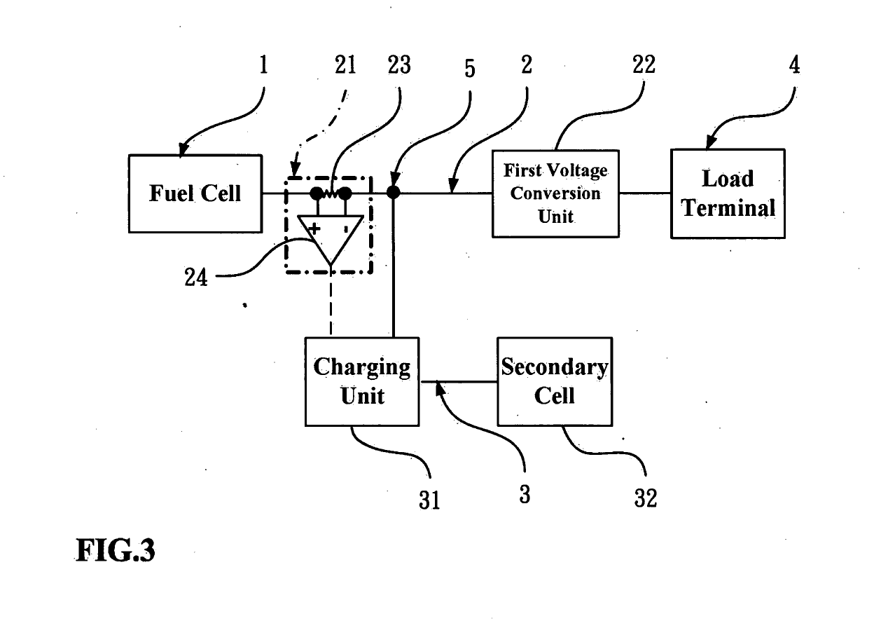

Referring to FIG. 3, which is the component diagram of the fuel cell apparatus with charge circuit according to the third embodiment of the invention. Based on the above-mentioned embodiment, the sensor unit (21) can comprise a resistance component (23) and a voltage differential amplifier (24). The resistance component (23) is electrically connected in series with the power output circuit (2). The voltage differential amplifier (24) is a voltage differential amplifier circuit composed of operational amplifiers, and two input terminals of the voltage differential amplifier (24) are electrically connected in parallel with two terminals of the resistance component (23) for comparing voltage difference of the two terminals of the resistance component (23). According to the voltage difference of the two terminals of the resistance component (23), a corresponding electrical signal is outputted from the output terminal of the voltage differential amplifier (24) to the charge circuit (3).

Therefore, according to the cross voltage difference of the resistance component (23), the voltage differential amplifier (24) of the sensor unit (21) outputs an electrical signal, and the sensor unit (21) transmits the electrical signal to the charging unit (31) of the charge circuit (3). The charging unit (31) increases current level of the charge circuit (3) to perform the charging operation of the secondary cell (32), so that the total output current or total output power of the fuel cell (1) is maintained in a stable state.

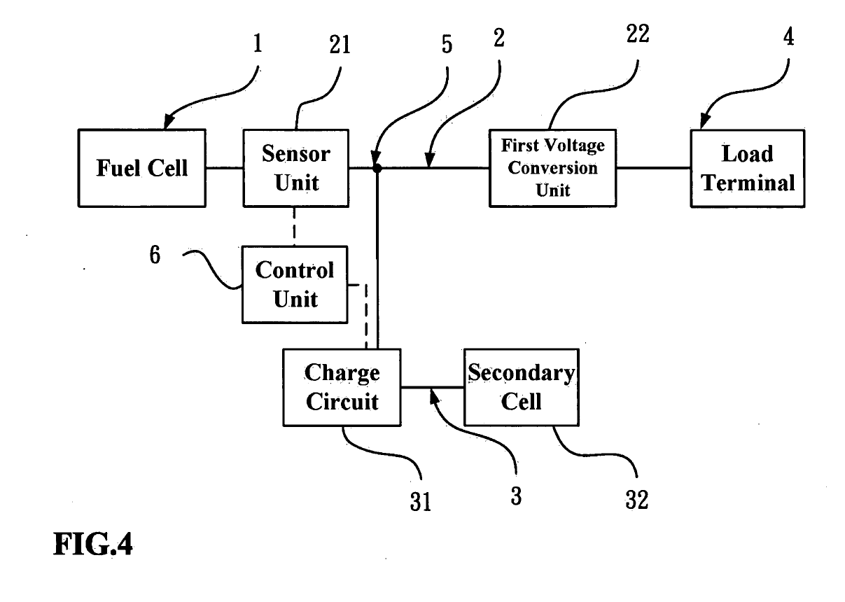

Referring to FIG. 4, which is the component diagram of the fuel cell apparatus with charge circuit according to the fourth embodiment of the invention. The above-mentioned fuel cell apparatus with charge circuit according to the invention can further comprise a control unit (6). The control unit (6) is electrically connected with the sensor unit (21) and the charging unit (31). The control unit (6) has functions of logic operation and control, and can control the operation of the charge circuit (3).

The output power of the fuel cell (1) is converted into the power needed by the load terminal (4) through the first conversion unit (22), and the control unit (6) transmits the electrical signal to the charging unit (31) so that the charging unit (31) converts and stores part of power of the fuel cell (1) to the secondary cell (32).

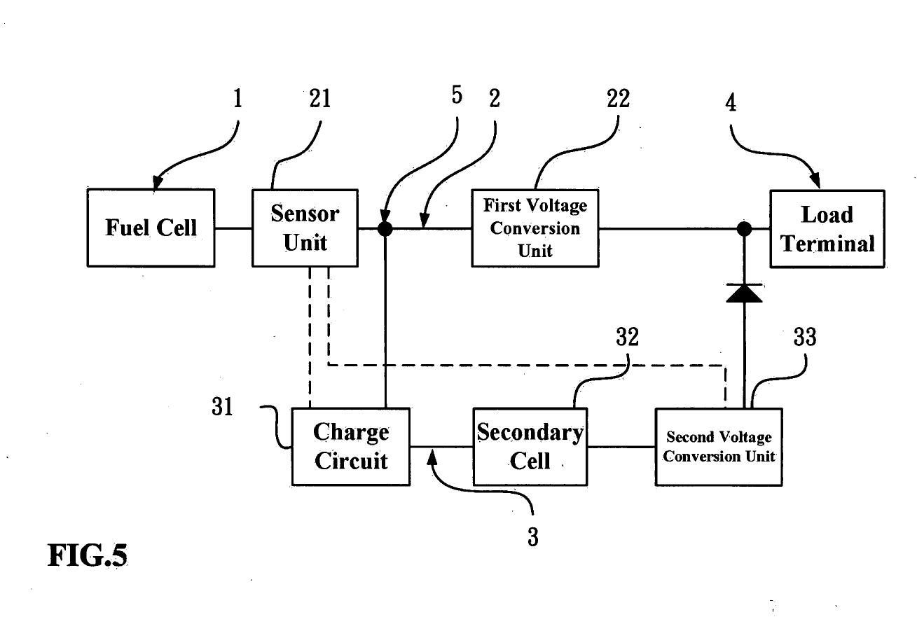

Referring to FIG. 5, which is the component diagram of the fuel cell apparatus with charge circuit according to the fifth embodiment of the invention. Based on the above-mentioned embodiment in the fuel cell apparatus with charge circuit of the invention, the charge circuit (3) further comprises a second voltage conversion unit (33). The second voltage conversion unit (33) is a circuit with DC power storage and release mechanism, and is electrically connected in series with the rear terminal of the secondary cell (32) of the charge circuit (3), so that the power outputted by the secondary cell (32) is converted into a stable voltage output. The second voltage conversion unit (33) can have a general current limiting mechanism. By reasonable control signals, the second voltage conversion unit (33) can control current level inputted into the second voltage conversion unit (33) or limit current level outputted from the first voltage conversion unit (22) to be not greater than a rated current value.

Thus, in the above-mentioned embodiment, the sensor unit (21) in the power output circuit (2) can detect the current level transmitted by the power output circuit (2). According to the preset output current level of the fuel cell (1) and the electrical signal provided by the sensor unit (21), the charging unit (31) correspondingly controls the current level of the charge circuit (3) to perform the charging operation of the secondary cell (32), and stabilizes the current level outputted by the fuel cell (1) in a preset range. Besides, the sensor unit (21) can control the charging unit (31) to increase or decrease the current level of the charge circuit (3) to perform the charging operation of the secondary cell (32), so that the total output current or total output power of the fuel cell (1) is maintained in a stable state. Besides, according to the signal provided by the sensor unit (21), the second voltage conversion unit (33) decreases the voltage of the output terminal of the secondary cell (32) to be not greater than the output terminal voltage of the first voltage conversion unit (22).

Furthermore, in the above-mentioned embodiment the charge circuit (3) is electrically connected in parallel with the power output circuit (2) to output power needed by the load terminal (4).

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fuel cell apparatus with charge circuit comprising:
a fuel cell;
a power output circuit, transmitting the power outputted by the fuel cell and further comprising a sensor unit, the sensor unit detecting the characteristics of the power outputted by the power output circuit and outputting the electrical signals corresponding to the foresaid characteristics; and
a charge circuit, transmitting power outputted by the fuel cell and comprising a secondary cell and a charging unit, the secondary cell being a chargeable power storage, apparatus, the charging unit being a power control apparatus and controlling the characteristics of the power outputted by the charge circuit, to perform charging of the secondary cell;
wherein the power output circuit is electrically connected in parallel with the charge circuit, while the fuel cell is electrically connected in series with the power output circuit, the sensor unit being electrically connected with the charging unit the charging unit determining power characteristics of the charge circuit charging the secondary cell, according to electrical signals outputted by the sensor unit.

2. The fuel cell apparatus with charge circuit according to claim 1, wherein according to electrical signals outputted by the sensor unit, the charging unit determines power characteristics of the charge circuit to supply the charging of the secondary cell and stabilizes current level transmitted by the power output circuit in the predetermined range.

3. The fuel cell apparatus with charge circuit according to claim 1, wherein according to electrical signals outputted by the sensor unit, the charging unit determines power characteristics of the charge circuit to supply the charging of the secondary cell and stabilizes current level outputted by the fuel cell in the predetermined range.

4. The fuel cell apparatus with charge circuit according to claim 1, wherein the sensor unit is disposed on the power output circuit and between the fuel cell and the terminal connecting the power output circuit and the charge circuit.

5. The fuel cell apparatus with charge circuit according to claim 1, wherein one terminal of the power output circuit electrically connects to the fuel cell, the other terminal is a load terminal for power output, and the sensor unit is disposed on the power output circuit and between the terminal connecting the power output circuit and the charge circuit and the load terminal.

6. The fuel cell apparatus with charge circuit according to claim 5, further comprising a first voltage conversion unit being a circuit with DC power storage and release mechanism, and being electrically connected in series with the power output circuit.

7. The fuel cell apparatus with charge circuit according to claim 6, wherein the first voltage conversion unit limits the output current value to be not greater than the predetermined current value.

8. The fuel cell apparatus with charge circuit according to claim 7, wherein when the current value outputted by the first voltage conversion unit is smaller than the predetermined current value, the charging unit increases the current level of the charge circuit to charge the secondary cell, and the output current of the fuel cell is maintained in a stable state.

9. The fuel cell apparatus with charge circuit according to claim 1, wherein the first voltage conversion unit comprises a DC-DC power boost circuit.

10. The fuel cell apparatus with charge circuit according to claim 1, wherein the first voltage conversion unit comprises a DC-DC power buck circuit.

11. The fuel cell apparatus with charge circuit according to claim 1, wherein the sensor unit further comprises:
a resistance component, being electrically connected in series with the power output circuit; and
a voltage differential amplifier, being a voltage differential amplifier circuit composed of operational amplifiers, and two input terminals of the voltage differential amplifier being electrically connected in parallel with two terminals of the resistance component;
wherein a electrical signal corresponding to the voltage difference of the two terminals of the resistance component, is outputted from the output terminal of the voltage differential amplifier to the charge circuit.

12. The fuel cell apparatus with charge circuit according to claim 1, further comprising a control unit, the control unit being electrically connected with the sensor unit and the charging unit, electrical signals outputted by the sensor unit, being processed by the control unit, and according to the electrical signals which are outputted by the sensor unit and then processed by the control unit, the charging unit controlling the characteristics of the power supplied by the charge circuit, to charge the secondary cell.

13. The fuel cell apparatus with charge circuit according to claim 1, further comprising a second voltage conversion unit, the second voltage conversion unit being a circuit with DC power storage and release mechanism, and being electrically connected in series with a rear terminal of the secondary cell of the charge circuit.

14. The fuel cell apparatus with charge circuit according to claim 13, wherein the second voltage conversion unit limits the output current value to be not greater than the predetermined current value.
